(19) United States
(12) Patent Application Publication
(10) Pub. No.: US 2009/0321184 A1
(43) Pub. Date: Dec. 31, 2009

(54) PORTABLE ANCHOR ASSEMBLY

(75) Inventor: Garry Ernest John Hamilton, Rosenort (CA)

Correspondence Address: IPLM GROUP, P.A., POST OFFICE BOX 18455, MINNEAPOLIS, MN, 55418, US

(73) Assignee: D B Industries, Inc.

(21) Appl. No.: 12/494,721

(22) Filed: Jun. 30, 2009

Related U.S. Application Data
(60) Provisional application No. 61/133,626, filed on Jun. 30, 2008.

(51) Int. Cl. A62B 35/00

(52) U.S. Cl. 182/3

(57) ABSTRACT

A portable anchor assembly is provided. The portable anchor assembly includes a weight assembly and a fork assembly. The weight assembly is configured to hold at least one weight. The weight assembly includes a portion that is configured to penetrate a surface upon which the portable anchor system is resting during use. The fork assembly is coupled to the weight assembly. The fork assembly is configured to dig into the surface upon which the portable anchor system is resting during use. The fork assembly further includes an anchor connection point for the portable anchor assembly.

### CROSS REFERENCE TO RELATED APPLICATIONS

The present application claims priority to Provisional Patent Application No. 61/133,626, having the same title herewith filed on Jun. 30, 2008 which is incorporated in its entirety herein.

### BACKGROUND

Anchor points or anchor devices with anchor points are used in conjunction with safety assistance systems to provide support to prevent unwanted falls. An issue arises when safety assistance systems are to be employed in areas not having a readily available anchor point or anchoring device. One method used to provide an anchor point is with drums poured with concrete. However, the drums are heavy and awkward to deploy and remove. Another method involves screw-in type ground engaging anchors. These types of anchors are expensive and require specialized equipment to install and remove. Yet another method involves pour-in-place concrete piles which are expensive to install, cannot be relocated and are difficult to remove when no longer needed. Hence, anchor systems currently in use have limitations.

For the reasons stated above and for other reasons stated below which will become apparent to those skilled in the art upon reading and understanding the present specification, there is a need in the art for an effective and efficient portable anchor assembly.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a portable anchor assembly is provided. The portable anchor assembly includes a weight assembly and a fork assembly. The weight assembly is configured to hold at least one weight. The weight assembly includes a portion that is configured to penetrate a surface upon which the portable anchor system is resting during use. The fork assembly is coupled to the weight assembly. The fork assembly is configured to dig into the surface upon which the portable anchor system is resting during use. The fork assembly further includes an anchor connection point for the portable anchor assembly.

### BRIEF DESCRIPTION OF THE DRAWINGS

The present invention can be more easily understood and further advantages and uses thereof more readily apparent, when considered in view of the detailed description and the following figures in which:

FIG. 1 is a front perspective view of a portable anchor system of one embodiment of the present invention;

FIG. 2 is a rear perspective view of a portable anchor system of another embodiment of the present invention;

FIG. 3 is a rear perspective view of a partially unassembled portable anchor system of FIG. 2;

FIG. 4 is a rear perspective view of the portable anchor system of FIG. 1 in a transport position without weight plates;

FIG. 5A is a front perspective view of a tension connector assembly of one embodiment of the present invention;

FIG. 5B is a front perspective view of the unassembled tension connector assembly of FIG. 5A;

FIG. 5C is a close up view of a portion of the tension connector assembly of FIG. 5A;

FIG. 6A is a front perspective view of fork assembly member of one embodiment of the present invention;

FIG. 6B is front perspective view of a portion of a fork assembly of one embodiment of the present invention;

FIGS. 7A through 7C illustrate a weight plate of one embodiment of the present invention;

FIG. 8 is a side view of a stake of one embodiment of the present invention;

FIG. 9 is a rear perspective view of a portable anchor system including a portable anchor assembly and an additional weight assembly of one embodiment of the present invention;

FIG. 10 is a side view of a portable anchor assembly in one embodiment in use with a climb assist system; and

FIG. 11 is a side view of a portable anchor assembly of one embodiment in use with an emergency rescue system.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that mechanical changes may be made without departing from the spirit and scope of the present invention. The following detailed description is, therefore, not to be taken in a limiting sense, and the scope of the present invention is defined only by the claims and equivalents thereof.

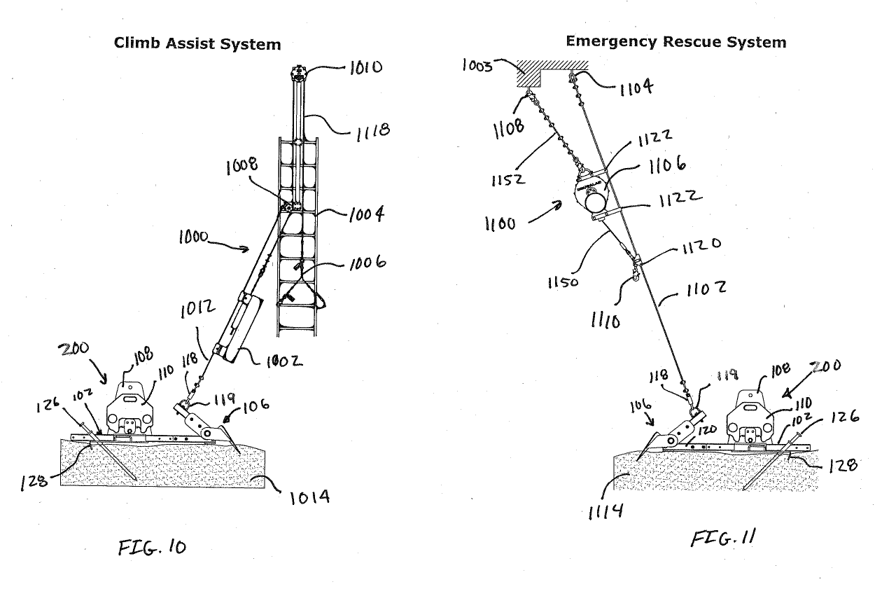

Embodiments of the present invention provide a portable anchor assembly. In particular, embodiments provide a weighted box with a rated anchor point, an ability to install counter weights and a method to connect the assembly to the ground to keep it from sliding. Moreover, embodiments of the portable anchor assembly can provide a self-standing, portable, ballasted, ground-engaging anchor assembly designed to resist the loads applied. An example application includes a use with a speed-controlling emergency descent/evacuation device such as the ROLLGLISS™ descender available from DBI/SALA of Red Wing, Minn. Another example use is as a portable anchor base for the ROLLGLISS™ descender units deployed on oil rig installation. Additional example applications of embodiments of the portable anchor assembly include but are not limited to a use as an anchor point for various other safety and material handling applications including horizontal lifelines across pits, fall restraint, fall arrest, climb assist systems and the like. Further example applications are discussed below in regards to FIGS. 10 and 11. Hence, it is recognized that embodiments could be used in any suitable application needing a portable support.

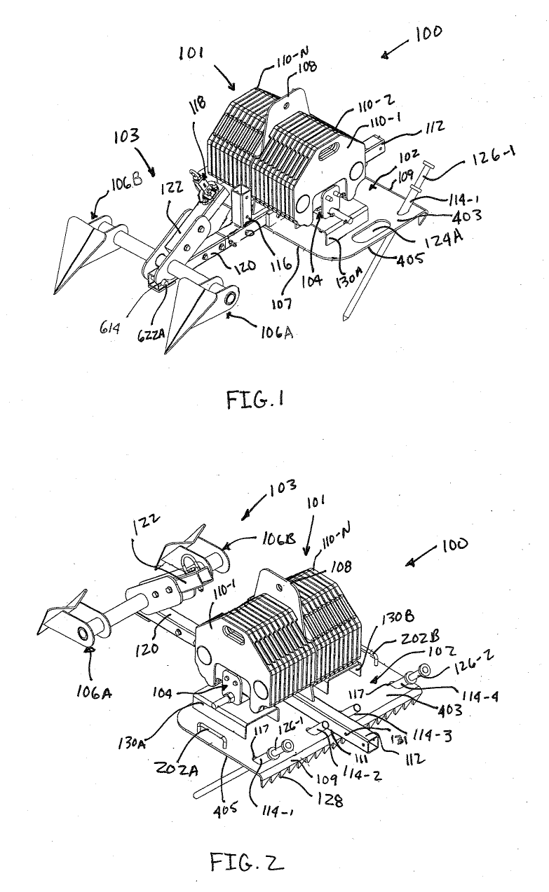

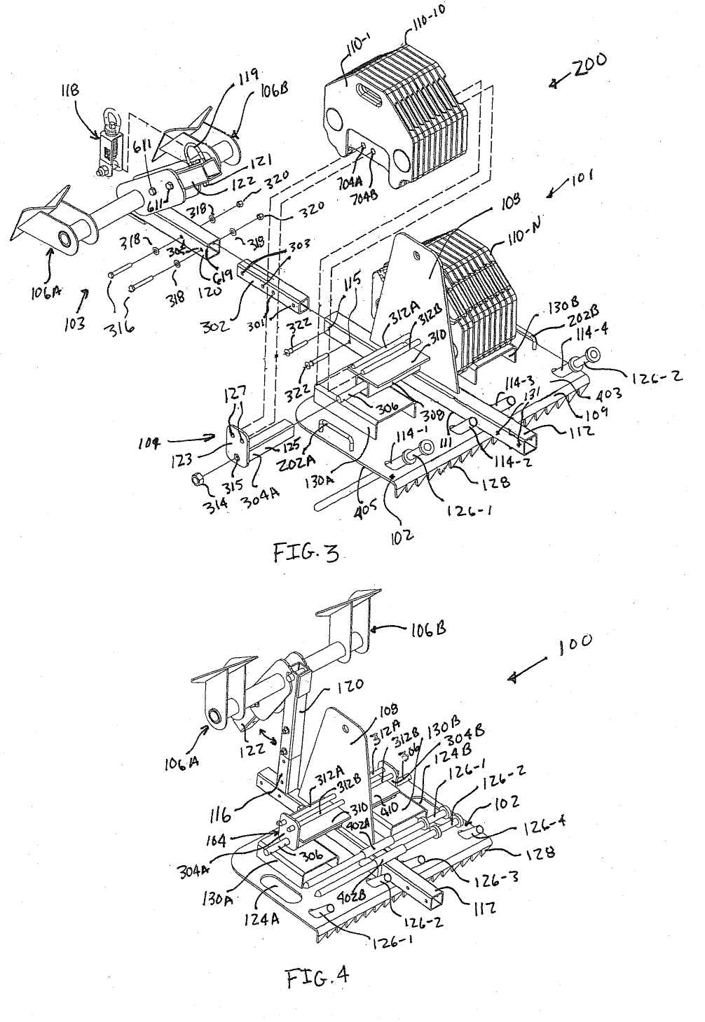

Embodiments of portable anchor assemblies are illustrated in FIGS. 1 through 4. In particular, FIG. 1 illustrates a front perspective view of a portable anchor assembly 100 of one embodiment. FIG. 2 illustrates a rear view of a portable anchor assembly 200 of an embodiment. FIG. 3 illustrates a rear perspective view of a partially unassembled portable anchor assembly 200 of FIG. 2, and FIG. 4 illustrates a rear perspective view of the portable anchor assembly 100 of FIG. 1 in a transport position. Portable anchor assemblies 100 and 200 have a majority of common parts and hereinafter are described together with their differences pointed out. The portable anchor assemblies 100 and 200 include a weight assembly 101 and a fork assembly 103. The weight assembly 101 includes a weight box base 102 and a weight plate attaching assembly 104. The weight plate attaching assembly 104 is coupled to the weight box base 102. The weight box base 102 is generally a flat plate having a length defined by a first end 107 and a second end 109. The weight box base 102 further has a first surface 403 and a second surface 405. The second surface 405 is positioned opposite the first surface 403. The weight plate attaching assembly 104 is coupled to the first surface 403 of the weight box base 102. The weight box base 102 has teeth 128 that extend downward from the second end 109 of the weight box base 102 beyond a plane formed by the second surface 405 of the weight box base 102.

Coupled along the length of the weight box base 103 is a main attaching member 112. This is best illustrated in FIG. 3. The main attaching member 112 is positioned along a mid-portion 111 of a width of the weight box base 102. In an embodiment, the main attaching member 112 extends out beyond the length of the weight box base 102. Further in an embodiment, the main attaching member 112 is a tube having a square cross-sectional shape. The main attaching member 112 has a plurality of attaching passages 115 and 131. Proximate the second end 109 of the weight box base 103 is a plurality of stake guides 114-1 through 114-4. Each stake guide 114-1 through 114-4 provides a guide for a stake through a passage 117 in the weight box base 102. Although only two stakes 126-1 and 126-2 are illustrated more stakes (or only one stake) can be used.) Although four stake guides 114-1 through 114-4 are illustrated, any number of stake guides could be used. One benefit of having a plurality of stake guides 114-1 through 114-4 is that it provides more options in the positioning of stakes 126-1 and 126-2. This become important when a hard object is encountered (such as a rock) when a stake is positioned in one of the stake guides 114-1 through 114-4.

The weight box base 102 includes at least one handle. In the embodiment of FIG. 1 (also illustrated in FIG. 4), handles 124A and 124B are openings in the weight box base 102 proximate edges that define the width of the weight box base 102. In FIG. 2 and FIG. 3, handles 202A and 202B are U-shaped rods extending from the first surface 403 of weight box base 102 proximate edges that define the width of the weight box base 102. Further coupled to the weight box base 102 is a first U-shaped support 130A and second U-shaped support 130B. The main attaching member 112 is positioned between the first U-shaped support 130A and the second U-shaped support 130B. The first U-shaped support 130A and the second U-shaped support 130B provide support for the weight plate attaching assembly 104.

Referring to FIG. 3, the weight plate attaching assembly 104 is described. The weight plate attaching assembly 104 includes a weight base 308 that is coupled across the first U-shaped support 130A and the second U-shaped support 130B. In one embodiment, the weight base 308 is a tube that has a square cross-sectional shape. In the embodiment illustrated in FIGS. 3 and 4, a mid support plate 108 is coupled to extend in a perpendicular direction from the weight base 308 and along a portion of a length of the main attaching member 112. In one embodiment (not shown) a mid support plate 108 is not used or does not extend beyond the height of weight plates 110-1 through 110-N. In the embodiment of FIGS. 3 and 4, a weight support plate 310 passes through the mid support plate 108 and is coupled to the weight base 308. In one embodiment, the weight support plate 310 is coupled to the mid support plate 108. In further another embodiment, the weight support plate 310 has two sections that do not pass through the mid support plate 108. Each section of the weight support plate 310 in this embodiment is coupled to a respective side of the mid support plate 108. A pair of weight guide rods 312A and 312B also pass through the mid support plate 108. In one embodiment, guide rods 312A and 312B are coupled to the mid support plate 108. Further in one embodiment, each guide rod 312A and 312B has two sections that do not pass through the mid support plate 108. In this embodiment, each section of each guide rod 312A and 312B is coupled to a respective side of the mid support plate 108.

The weight guide rods 312A and 312B provide guides for weights 110-1 through 110-N. In particular, weights 110-1 through 110-N each have guide holes 704A and 704B in which the respective weight guide rod 312A and 312B is received when a respective weight is mounted on the weight plate attaching assembly 104. As illustrated, a plurality of weights 110-1 through 110-N can be mounted on either side of the mid support plate 108. Any number of weights 110-1 through 110-N can be used depending on the application. The weights 100-1 through 110-N can generally be referred to as weights 110. The weights 110 are further discussed in regards FIGS. 7A through 7C. In particular, FIG. 7A illustrates a front view of a weight plate 110, FIG. 7B illustrates a side view of the weight plate 110 and FIG. 7C illustrates a back view of a weight plate 110. Weight 110 includes weight guide holes 704A and 704B. As discussed above, the weight guide holes 704A and 704B receive the weight guide rods 312A and 312B of the weight plate attaching assembly 104. Also illustrated is a cutout section 706 proximate a bottom of the weights 110. Cutout section 706 is designed to receive the weight support plate 310 of the weight plate attaching assembly 104. Finally, weight plate 110 includes handle 702 (which is a handle opening) for ease of moving weights 110 on and off of the weight plate assembly 104.

Referring back to FIGS. 3 and 4, the weights 110 are retained on the weight plate attaching assembly 104 via weight retaining members 304A and 304B. In one embodiment, bar 306 is positioned within a channel formed by the cross-sectional shape of the weight base 308. In one embodiment the bar 306 has threaded ends. The weight retaining members 304A and 304B include a plate portion 123 and a receiving portion 125. Referring to weight retaining member 304A, the receiving portion 125 is received within the weight base 308. Plate portion 123 of the weight retaining members 304A and 304B includes a retaining aperture 315 in which the threaded end of rod 306 passes through and two guide apertures 127 in which the weight guide rods 312a and 312B pass through. Once positioned, a threaded nut 314 threadably engages the threaded end of rod 308 thereby retaining the weight retaining member 304 on the weight plate attaching assembly 104 to lock the weights 110 in place. Hence, in embodiments since the weights 110 can be added or removed, a select amount of weights 110 can be used depending on the application as discussed above. Moreover, since the weights 110 can be removed from the portable anchor assembly 100 and 200, portability of the assemblies 100 and 200 is enhanced.

The fork assembly includes first and second fork assembly members 106A and 106B, fork attaching member 120 and a connector support member 122. The fork attaching member 120 is coupled to the weight assembly 101. Referring to FIG. 3, the connection between the fork attaching member 120 and the weight assembly 101 is described. A first portion of a connecting member 302 is received in main attaching member 112 of the weight assembly 101 such that passages 115 of the main attaching member 112 align with passages 301 in connecting member 302. Fasteners 322 are then passed through the aligned passages 115 and 301 to attach the connecting member 302 to the main attaching member 112 of the weight assembly 101. In one embodiment the fasteners 322 are spring loaded ring detent pins that allow for quick attachment and detachment. Another second portion of the connecting member 302 is received in a first end 619 of the fork attaching member 120 such that passages 303 on the connecting member 302 align with passages 305 in the fork attaching member 120. Fasteners 316 are passed through the passages 305 and 303 to connect the fork attaching member 120 to the connection member 302 thereby connecting the fork assembly 103 to the weight assembly 101. In one embodiment the fasteners include bolts 316, washers 318 and nuts 320.

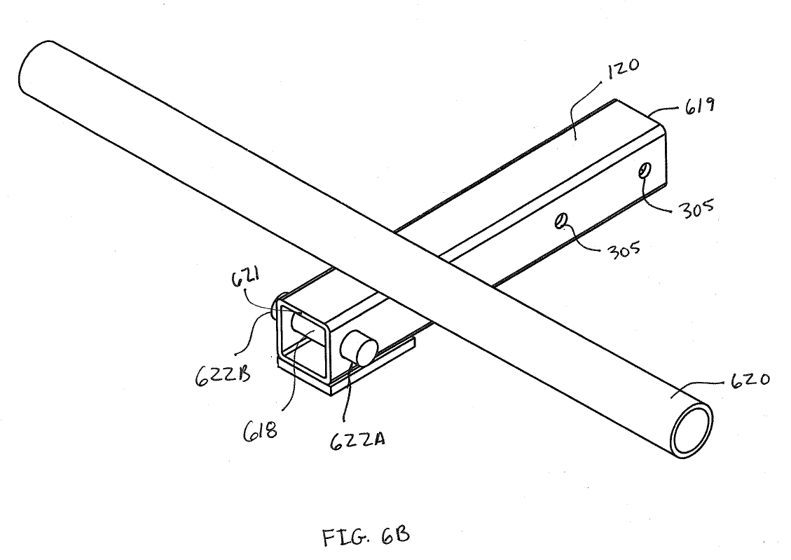

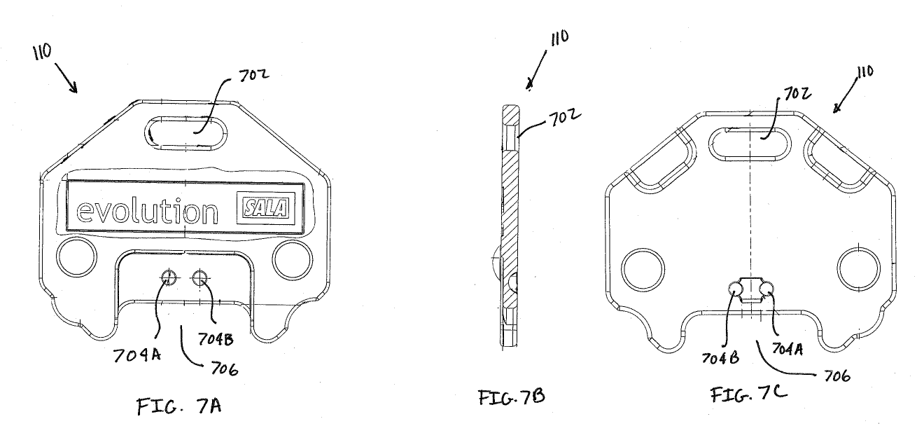

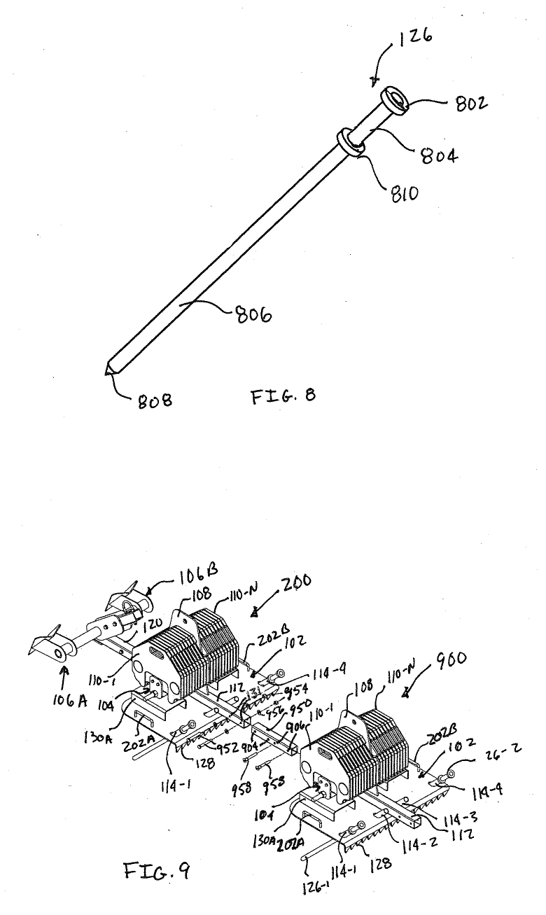

An example of an embodiment of fork assembly member 106B is illustrated in FIG. 6A. The fork assembly member 106B includes a fork 602 that is generally triangular in shape with a pointed end 601 to dig into a surface. The fork 602 is coupled proximate a first end of a fork sleeve 606 via arms 604A and 604B. Coupled proximate a second end 607 of the fork sleeve 606 is fork attaching bracket 608. The fork attaching bracket 608 includes attaching apertures 612A and 612B. Referring to FIG. 6B an illustration of a portion of the fork attaching member 120. As illustrated, a mid portion of an inner sleeve tube 620 is coupled to an outside surface of the fork attaching member 120 proximate a second end 621 of the fork attachment member 120. Also illustrated in FIG. 6B is an anchor tube stopper 618 that passes through the fork attaching member 120 near the second end 621 of the fork attaching member 120. The fork sleeve 606 of the fork assemblies 106A and 106B fit over inner sleeve tube 620. When inner sleeve tube 620 is received in the fork sleeve 606, catch portion 614 of the fork attaching bracket 608 is positioned to abut a second end 622B of the anchor tube stopper 618 passing through the fork attaching member 120. Similarly, fork assembly 106A will have a catch portion of its fork attaching bracket positioned to abut a first end 622A of the anchor tube stopper 618. This feature can further be seen in FIG. 1.

The fork attaching bracket 608 of fork assemblies 106B and 106A are coupled proximate a first end of a connector support member 122 via fasteners passing through attaching apertures 612A and 612B and aligned passages in the connection support member 122. Referring back to FIG. 3, a ring connector 119 is coupled proximate a second end of the connector support member 122. The ring connector 119 can be referred to as an anchor connection point. The anchor connection point 119 provides the point where the portable anchor assembly 100 is connected for use. When a cable or the like is attached to the anchor connection point 119 and a pull force or tension is asserted, the fork assembly members 106A and 106B dig into a surface upon which the portable anchor assembly 100 or 200 is resting to prevent the portable anchor assembly 100 or 200 from sliding toward the pull force. In one embodiment a tension connector assembly 118 is used at the anchor connection point 119. The tension connector assembly 118 provides an indication of the tension (pull force) being applied to the portable anchor assembly 100 or 200.

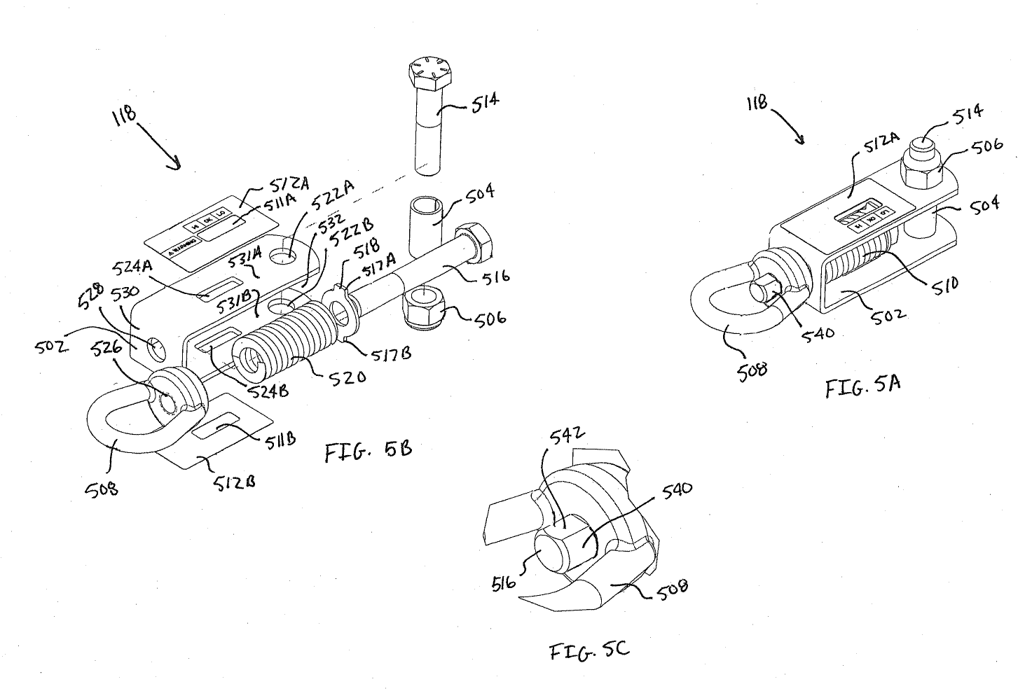

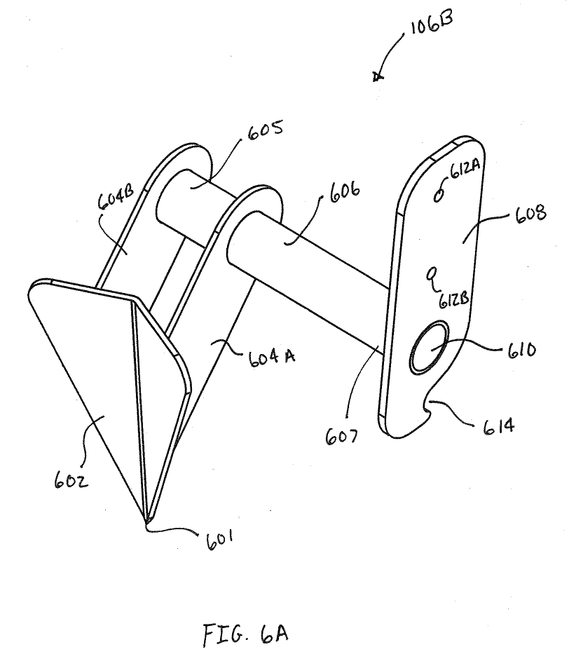

An embodiment of the tension connector assembly 118 is illustrated in FIGS. 5A, 5B and 5C. The tension connector assembly 118 in this embodiment includes a U-shape frame 502 having a closed end 530, an open end 532 and opposing sides 531A and 531B. A biasing member 520 is positioned between the opposing sides 531A and 531B. The biasing member 520 has an internal passage that is aligned with a frame passage 528 in the closed end 530 of the frame 502. In one embodiment, the biasing member 520 is a spring having a select amount of stiffness. A washer 518 is positioned on a fastener 516 that is passed through the internal passage of the biasing member 520 and the frame passage 528. In one embodiment the fastener 516 is a bolt 516 having exterior threads. An end of bolt 516 passes through the frame passage 529 and through an eye nut passage 526 of eye nut 508. A nut 540 is threadably engaged with the threads of the bolt 516 to retaining the eye nut 508 and biasing member 720 in place. To ensure nut 540 does not come unthreaded from the bolt 516, a portion 542 of the external threads of the bolt 516 are ground down. Labels 512A and 512B are posited on the respective opposing sides 531A and 531B. The labels 512A and 512B have windows 511A and 511B respectively that align with window passages 524A and 524B in the opposing sides 531A and 531B of the frame 502. Tab portions 517A and 517B of the washer 518 are received in the respective window passages 524A and 524B of the frame 502. The respective tab portions 517A and 517B indicate the amount of tension attached to the eye nut 508 of the tension connector assembly 118 via their position in relation to indications on the labels 512A and 512B. Hence, the stiffness of the biasing member 520 is selected to accurately indicate the tension force as indicated by the washer tab portions 517A and 517B in relation to the labels 512A and 512B.

The tension connector assembly 118 further includes another fastener used to couple the connection member 118 to the ring connector 119 of the connector support member 122. In one embodiment the fastener includes a bolt 514, spacer 504 and a nut 506. The spacer 504 is positioned between the opposing sides 531A and 531B proximate the open end 532 of the frame 502. The spacer 504 has a passage that aligns with apertures 522A and 522B in the opposing sides 531A and 531B of the frame 502. Bolt 514 passes through apertures 522A and 522B and the spacer 504. Bolt 514 is retained in the frame 502 via nut 506 engaging external threads on the bolt 514. Referring to FIG. 3, the ring connector 119 is positioned within the opposing sides 531A and 531B of the frame 502 of the connection assembly before the fastener, made up of bolt 514, spacer 504 and nut 506 are assembled.

As briefly discussed above, FIG. 4 illustrates a portable anchor assembly 100 without weights in a transport position. This transport position may be used during shipping to a customer or when transporting the portable anchor assembly 100 to a work location. In this embodiment a T connector 116 is coupled to the main attachment member 112. The T connector 116 is also illustrated in FIG. 1. As illustrated in FIG. 4, the T connector 116 allows the fork assemblies 106A and 106B to be positioned closer to the weight box base 102 to reduce the overall length of the portable anchor assembly 100 during transport. Once at the implementation site, the fork attaching member 120 is disconnected from the portion of the T connector 116 that is perpendicular to the main attaching member 112 and connected to the portion of the T connector 116 that is in line with the main attaching member 112. In addition, since the fork assembly members 106A and 106B are rotationally coupled to the inner sleeve tube 620, connection support member 122 can be rotated to be adjacent the fork attaching member 120 to further decrease the overall length of the portable anchor assembly 100 for storage or transport. Also illustrated in FIG. 4 are stake holding sleeves 402A and 402B coupled to the main attaching member 112 in this embodiment. The stake holding sleeves 402A and 402B are used to hold the stakes 126-1 and 126-2 during transport. An example of a stake 126 is illustrated in FIG. 8. The stake 126 in this embodiment includes a shaft 806 that has a pointed end 808 that is designed to be driven into the ground. The other end of the shaft 806 is connected to a handle 804. A collar 810 separates the shaft 806 from the handle 804. The handle 804 terminates in a head 802 that is designed to be struck with a mallet or the like to drive the stake into the ground.

FIG. 9 illustrates a rear perspective view of an anchoring system of an embodiment that includes a portable anchor assembly 200 and an additional weight assembly 900. Hence, in this modular system, if the situation warrants (i.e. the work site soil or other conditions necessitate additional weight), more than one weight assembly 900 can be used. As illustrated, a connection member 950 is used to connect the main attaching member 112 of the portable anchor assembly 200 to the additional weight assembly 900. In an embodiment, a first portion of the connection member 950 is received in the main attaching member 112 of the portable anchor assembly 200 such that passages 904 in the connection member 950 align with passages 131 in the attaching member 112 of the portable anchor assembly 200. Fasteners passing through the passages 131 and 904 connect the connection member 950 to the main attaching member 112 of the portable anchor assembly 200. In one embodiment, the fasteners include bolts 952, washers 956 and nuts 954. A second portion of the connection member 950 is received in the main attaching member 112 of the weight assembly 900. Passages 906 in the second portion of the connection member 950 align with passages (not shown) in the main attaching member 112 of weight assembly 900. Fasteners, such as fasteners 958 passing through the passages 906 connect the connection member 950 to the weight assembly 900. In one embodiment the fasteners 958 are quick release fasteners such as spring loaded ring detent pins. Hence, in embodiments, any number of weight assemblies 900 can be used depending on the situation.

Examples of an embodiment of a portable anchor assembly 200 in use are illustrated in FIG. 10 and FIG. 11. Generally in use, the portable anchor assembly 200 is placed at a desired location. One or more stakes 126 are then driven through a surface upon which the weight assembly 101 is resting using select stake guides 114-1 through 114-N of the weight box base 102. A select number of weight plates 110 needed for the application are then attached to the weight assembly 101. The tension connector assembly 118 is then coupled for use as illustrated in FIGS. 10 and 11. The tension connector assembly 118 can then be monitored to make sure the tension on the tension connector assembly 118 is within a predetermined safe range.

FIG. 10 illustrates a side view of a portable anchor assembly 200 in use with a climb assist system 1000. The climb assist system 1000 includes a ladder 1004 having a sheave assembly 1008 attached thereto. The sheave assembly 1008 guides an assist cable 1018 that is routed around a safety block 1010. The assist cable 1018 is connected to an attaching system 1006 upon which a safety harness can be attached. The climb assist system 1000 also includes a counter weight 1002. The counter weight 1002 is slidably attached to an anchor cable 1012 in this embodiment. The anchor cable 1012 is coupled between the tension connector assembly 118 of the portable anchor assembly 200 and the sheave 1008 of the climb assist system 1000. As illustrated, a fork 602 of the portable anchor assembly 200 digs into the ground 1014 while in use to prevent the portable assembly from sliding toward a pull force on the tension connector assembly 118. Also illustrated, a spike 126 is driven into the ground 1014 to help retain the portable anchor assembly 200 in place. Teeth 128 of the weight box base 102 of the portable anchor assembly 200 also engage the ground 1014 to prevent movement of the portable anchor assembly 200 while in use.

In FIG. 11, a side view of a portable anchor assembly 200 in use with an emergency rescue system 1100 is illustrated. The emergency rescue system 1100 includes a main cable 1102 that is connected between a support 1103 via connector 1104 and the tension connector assembly 118 of the portable anchor assembly 200. The emergency rescue system 1100 further includes an emergency descent device 1106. The descent device 1106 is also coupled to the support via secondary cable 1152 and connector 1108. The descent device 1106 is further coupled to the main cable 1102 via cable suspension bars 1122. The descent device 1106 further includes a descent cable 1150 that terminates in a connection member 1110 that can be coupled to a safety harness of a user. The connection member 1110 in this example is slidably coupled to the main cable 1102 via guide cable sheave 1120. As FIG. 11 illustrates, the fork 106, the teeth 128 and the spike 126 of the portable anchor system 200 all penetrate the surface of the ground 1114 to prevent the portable anchor system 200 from moving during use because of a force on the anchor connection point 119.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A portable anchor assembly comprising:
a weight assembly configured to hold at least one weight, the weight assembly including a portion configured to penetrate a surface upon which the portable anchor assembly is resting during use; and
a fork assembly coupled to the weight assembly, the fork assembly configured to dig into the surface upon which the portable anchor system is resting during use, the fork assembly further including an anchor connection point for the portable anchor assembly.

2. The portable anchor assembly of claim 1 wherein the weight assembly further comprises:
a weight box base having a length defined by a first end and a second end, the weight box base further having a first surface and a second surface positioned opposite the first surface; and
a weight plate attaching assembly coupled to the first surface of the weight box base, the weight plate attaching assembly configured to attached the at least one weight to the weight box base.

3. The portable anchor assembly of claim 2, wherein the weight box base further comprises:
teeth extending along the second end of the weight box base beyond a plane formed by the second surface, the teeth configured to penetrate the surface upon which the weight box base is resting.

4. The portable anchor assembly of claim 2, wherein the weight box base further comprises:
at least one stake guide providing a passage through the weight box base, the at least one stake guide configured to provide a guide for stakes used to secure the weight box base to the surface the weight box base is resting upon.

5. The portable anchor assembly of claim 2, wherein the weight plate attaching assembly further comprises:
at least one weight guide rod configured be received in an aperture of the at least one weight; and
at least one weight retaining member selectively coupled to retain the at least one weight on the at least one weight guide rod.

6. The portable anchor assembly of claim 1, further comprising:
at least one handle configured to aid in the lifting of the portable anchor system.

7. The portable anchor assembly of claim 2, further comprising:
a main attaching member coupled across a length of the weight box base 102.

8. The portable anchor assembly of claim 7, further comprising:
the main attaching member having a first end selectively coupled to the fork assembly.

9. The portable anchor assembly of claim 8, further comprising:
the main attaching member having a second end, the second end configured to be selectively attached to another different weight assembly.

10. The portable anchor assembly of claim 1, wherein the fork assembly further comprises;
at least one fork assembly member having a fork including a tip shaped to protrude into the surface;
a fork attaching member rotationally coupled to the at least one fork assembly member, the fork attaching member further selectively coupled to the weight assembly; and
a connection support member coupled to the at least one fork assembly member, the connection support member further including the anchor connection point.

11. The portable anchor assembly of claim 10, wherein the fork assembly further comprises;
an inner sleeve tube coupled to the fork attaching member; and
each fork assembly member including,
at least one arm having a first end coupled to the fork,
a fork sleeve coupled to a second end of the at least one arm, the fork sleeve received over the inner sleeve tube of the fork assembly, and
a fork attaching bracket coupled to the fork sleeve, the fork attaching bracket further coupled to the connection support member.

12. The portable anchor assembly of claim 1, further comprising:
a tension connector assembly coupled to the anchor connection point of the fork assembly, the tension connector assembly configured to provide an indication of a force coupled to the portable anchor assembly.

13. The portable anchor assembly of claim 13, wherein the tension connector assembly further comprises:
a U-shaped frame having a closed end, an open end, a first side and a second side, the closed end having an aperture;
a biasing member positioned within the U-shaped frame;
a first fastener passing through the biasing member, a threaded portion of the first fastener further passing through the aperture in the closed end of the U-shaped frame;
a washer received around the first fastener, the washer positioned between a head of the first fastener and the biasing member, the washer including opposing tabs, each tab being received in respective openings in the first and second sides of U-shaped frame;
an eye nut threadably engaged to the threaded portion of the first fastener that passes through the aperture in the closed end of the U-shaped frame;
indicia positioned near the openings indicating the force on the eye nut based on the position of the respective tabs of the washer;
a spacer providing a passage between apertures in the first and second sides of the U-shaped frame proximate the open end of the U-shaped frame;
a second fastener passing through apertures in the first and second sides of the U-shaped frame proximate the open end and through the spacer; and
a nut threadably engaged with threads of the second fastener.

14. A portable anchor assembly comprising:
a weight assembly to hold at least one removable weight plate, the weight assembly including at least one stake guide to secure the weight assembly to a surface upon which the portable anchor assembly is resting on during use; and
a fork assembly selectively coupled to the weight assembly, the fork assembly including at least one fork to dig into the surface the portable anchor assembly is resting on during use, the fork assembly further including an anchor connection point for the portable anchor assembly.

15. The portable anchor assembly of claim 14, further comprising:
a tension connector assembly coupled to the anchor connection point for the fork assembly, the tension connector assembly configured to provide an indication of a tension force coupled to the portable anchor assembly.

16. The portable anchor assembly of claim 15, wherein the tension connector assembly further comprises:
a U-shaped frame having a closed end, an open end, a first side and a second side, the closed end having an aperture;
a biasing member positioned within the U-shaped frame;
a first bolt passing through the biasing member, a threaded portion of the first bolt further passing through the aperture in the closed end of the U-shaped frame;
a washer received around the first bolt, the washer positioned between a head of the first bolt and the biasing member, the washer including opposing tabs, each tab being received in respective openings in the first and second sides of U-shaped frame;
an eye nut threadably engaged to the threaded portion of the first bolt that passes through the aperture in the closed end of the U-shaped frame;
indicia positioned near the openings indicating the tension on the eye nut based on the position of the respective tabs of the washer;
a spacer providing a passage between apertures in the first and second sides of the U-shaped frame proximate the open end of the U-shaped frame;
a second bolt passing through apertures in the first and second sides of the U-shaped frame proximate the open end and through the spacer; and
a nut threadably engaged with threads of the second bolt, wherein the spacer is engaged with the anchor connection point.

17. The portable anchor assembly of claim 14 wherein the weight assembly further comprises:
a weight box base having a length defined by a first end and a second end, the weight box base further having a first surface and a second surface positioned opposite the first surface;
teeth extending along the second end of the weight box base beyond a plane formed by the second surface, the teeth configured to penetrate the surface upon which the weight box base is resting; and
a weight plate attaching assembly coupled to the first surface of the weight box base, the weight plate attaching assembly attaching the at least one removable weight plate to the weight box base.

18. The portable anchor assembly of claim 14 further comprising:
a main attaching member coupled across a length of the weight assembly, the main attaching member having a first end selectively coupled to the fork assembly, the main attaching member having a second end, the second end configured to be selectively attached to another different weight assembly.

19. The portable anchor assembly of claim 14, further comprising:
a plurality of weight plates, each weight plate configured to be detachably coupled to the weight assembly.

20. A portable anchor assembly comprising:
a weight assembly including,
a weight box base having a length defined by a first end and a second end, the weight box base further having a first surface and a second surface positioned opposite the first surface,
a weight plate attaching assembly coupled to the first surface of the weight box base, the weight plate attaching assembly attaching at least one removable weight plate to the weight box base, and
teeth extending along the second end of the weight box base beyond a plane formed by the second surface, the teeth configured to penetrate a surface upon which the portable anchor assembly is resting on during use; and
a fork assembly including,
at least one fork including a tip, the tip shaped to penetrate into the surface upon which the portable anchor assembly is resting during use,
a fork attaching member rotationally coupled to the at least one fork, the fork attaching member further selectively coupled to the weight assembly, and
a connection support member coupled to the at least one fork, the connection support member further including an anchor connection point.

21. The portable anchor assembly of claim 20, wherein the weight box base of the weight assembly further comprises:
at least one stake guide providing a passage through the weight box base, the at least one stake guide providing a guide for stakes used to secure the weight box base to the surface the weight box base is resting upon during use.

22. The portable anchor assembly of claim 20, further comprising:
a connector assembly coupled to the anchor connection point of the connection support of the fork assembly, the connector assembly including,
a U-shaped frame having a closed end, an open end, a first side and a second side, the closed end having an aperture;
a biasing member positioned within the U-shaped frame;
a first bolt passing through the biasing member, a threaded portion of the first bolt further passing through the aperture in the closed end of the U-shaped frame;
a washer received around the first bolt, the washer positioned between a head of the first bolt and the biasing member, the washer including opposing tabs, each tab being received in respective openings in the first and second sides of U-shaped frame;
an eye nut threadably engaged to the threaded portion of the first bolt that passes through the aperture in the closed end of the U-shaped frame;
indicia positioned near the openings indicating the tension on the eye nut based on the position of the respective tabs of the washer;
a spacer providing a passage between apertures in the first and second sides of the U-shaped frame proximate the open end of the U-shaped frame;
a second bolt passing through apertures in the first and second sides of the U-shaped frame proximate the open end and through the spacer; and
a nut threadably engaged with threads of the second bolt, wherein the connector assembly provides an indication of a force coupled to the portable anchor assembly.
